(19) United States
(12) Patent Application Publication
(10) Pub. No.: US 2016/0045924 A1
(43) Pub. Date: Feb. 18, 2016

(54) MULTI-PURPOSE FLUID SUPPLY DEVICE

(71) Applicant: ZONEKING INDUSTRIAL CO., LTD., Taichung City (TW)

(72) Inventors: CHI-SHENG LIN, Taichung City (TW); CHIN-CHOU LIN, Taichung City (TW)

(21) Appl. No.: 14/458,353

(22) Filed: Aug. 13, 2014

(51) Int. Cl. B05B 7/00; B05B 7/12

(52) U.S. Cl. CPC B05B 7/0025; B05B 7/12

(57) ABSTRACT

A multi-purpose fluid supply device includes a main body portion, a working portion, a bubble generation portion, and a fluid guide portion. The multi-purpose fluid supply device can be changed among an air spray mode, a dust collection mode, a water spray mode and a bubble spray mode so as to achieve a four-in-one gun. The multi-purpose fluid supply device is mobile and can be used widely.

### BACKGROUND OF THE INVENTION

1. Field of the Invention

The present invention relates to a multi-purpose fluid supply device, and more particularly, to a four-in-one gun which is mobile and can be used widely.

2. Description of the Prior Art

A conventional spray gun for washing cars uses a spray gun to connect with a liquid supply source and a high-pressure motor. Through the high-pressure gas to bring the liquid, the car is washed. This apparatus is suitable for a professional car wash, not for a domestic or individual car wash.

A bubble generation device used for a bubble spray gun comprises a liquid container connected at the front end of the gun body and a bubble generator. The bubble generation device comprises a foam member and a buffer therein. When the gun body is pressed to supply the high-pressure gas, the gas brings the liquid to pass the foam member and the buffer. Through the refining effect of the foam member and the buffering and distribution effect of the buffer, the gun provides a bubble spray function.

However, the route to form bubbles is not long enough, so the amount of the bubbles is not enough.

In addition, the conventional air spray guns, dust collection guns, water spray guns, and bubble spray guns are a known technique. So far, there is no device to combine the aforesaid four guns to become one. Accordingly, the inventor of the present invention has devoted himself based on his many years of practical experiences to solve these problems.

### SUMMARY OF THE INVENTION

The primary object of the present invention is to provide a multi-purpose fluid supply device which is a four-in-one gun to be used widely. The present invention is to combine the functions of the conventional air spray guns, dust collection guns, water spray guns, and bubble spray guns to become a four-in-one gun.

In order to achieve the aforesaid object, the multi-purpose fluid supply device comprises a main body portion, a working portion, a bubble generation portion, and a fluid guide portion. The main body portion is provided with a fluid supply device. The fluid supply device is changeable between an open position and a closed position. When the fluid supply device is located at the open position, it is adapted to supply one of a gas and a liquid. The working portion is connected to the main body portion. The working portion has a first working end and a second working end. The fluid supply device, the first working end, and the second working end communicate with each other. The first working end is changeable among an air spray position, an air suction position, a liquid spray position, and a bubble spray position. The second working end is changeable among a working position, a dust collection position, and a supply position. The bubble generation portion has a disconnection position and a connection position to disconnect from or connect with the first working end, respectively. The fluid guide portion is changeable between a forward position and a rearward position.

Accordingly, the multi-purpose fluid supply device can be changed among the following four modes:

Air spray mode: The fluid supply device is located at the open position. The first working end is located at the air spray position. The second working end is located at the working position. The bubble generation portion is at the disconnection position. The fluid guide portion is located at the forward position. The fluid supply device supplies the gas. The fluid guide portion guides the gas to be sprayed through the first working end.

Dust collection mode: The fluid supply device is located at the open position. The first working end is located at the air suction position. The second working end is located at the dust collection position. The bubble generation portion is located at the disconnection position. The fluid guide portion is located at the rearward position. The fluid supply device supplies the gas. The fluid guide portion guides the gas to collect dust from the first working end toward the second working end.

Water spray mode: The fluid supply device is located at the open position. The first working end is located at the liquid spray position. The second working end is located at the supply position. The bubble generation portion is located at the disconnection position. The fluid guide portion is located at the forward position. The second working end supplies a working fluid which is a liquid. The fluid supply device supplies the gas. The fluid guide portion guides the gas toward the first working end to bring the working fluid to spray water.

Bubble spray mode: The fluid supply device is located at the open position. The first working end is located at the bubble spray position. The second working end is located at the supply position. The bubble generation portion is located at the connection position. The fluid guide portion is located at the forward position. The second working end supplies the working fluid which is a gas. The fluid supply device supplies the liquid. The working fluid is guided by the fluid guide portion to bring the liquid toward the first working end to pass the bubble generation portion. During passing, the liquid is extruded repeatedly to spray bubble toward the first working end.

### BRIEF DESCRIPTION OF THE DRAWINGS

FIG. 1 is a schematic view of the air spray gun of the present invention;

FIG. 2 is an exploded view of FIG. 1;

FIG. 3 is a sectional view of FIG. 1;

FIG. 4-A is a schematic view of the air spray gun of the present invention when in use;

FIG. 4-B is a perspective view of FIG. 4-A;

FIG. 4-C is an exploded view of FIG. 4-A;

FIG. 4-D is a sectional view of FIG. 4-A;

FIG. 5 is a schematic view of the dust collection gun of the present invention;

FIG. 6 is a schematic view of the water spray gun of the present invention;

FIG. 7 is an exploded view of FIG. 6;

FIG. 8 is a sectional view of FIG. 6;

FIG. 9 is a schematic view of FIG. 6 when in use;

FIG. 10 is a schematic view of another embodiment of FIG. 6;

FIG. 11 is a schematic view of the bubble spray gun of the present invention;

FIG. 12 is a schematic view of FIG. 11 when in use;

FIG. 13 is a schematic view of another embodiment of FIG. 12;

FIG. 14 is a schematic view of FIG. 13;

FIG. 15 is a sectional view of FIG. 14;

FIG. 16 is a sectional view of FIG. 14 seen at another angle; and

FIG. 17 is a schematic view of FIG. 16 when in use.

### DETAILED DESCRIPTION OF THE PREFERRED EMBODIMENTS

Embodiments of the present invention will now be described, by way of example only, with reference to the accompanying drawings.

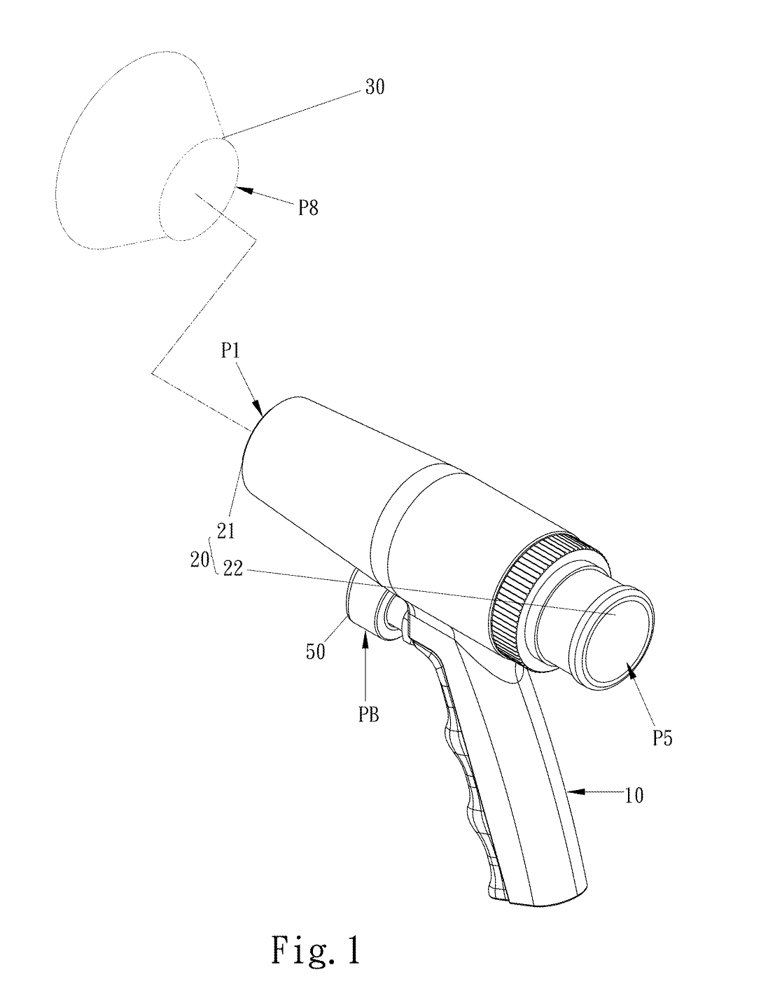

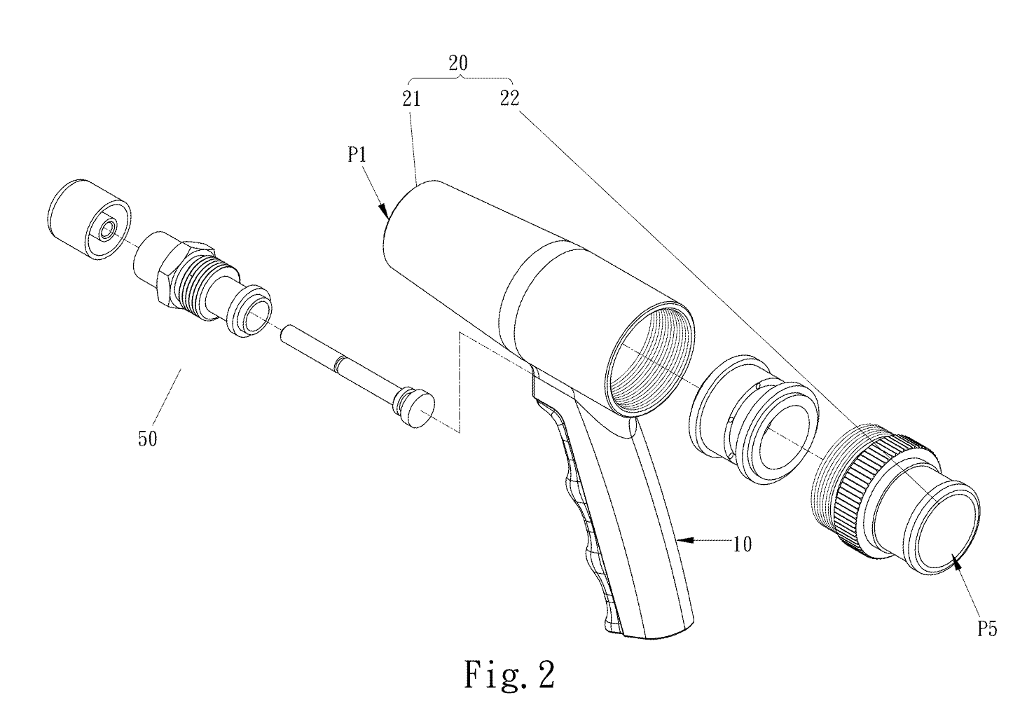

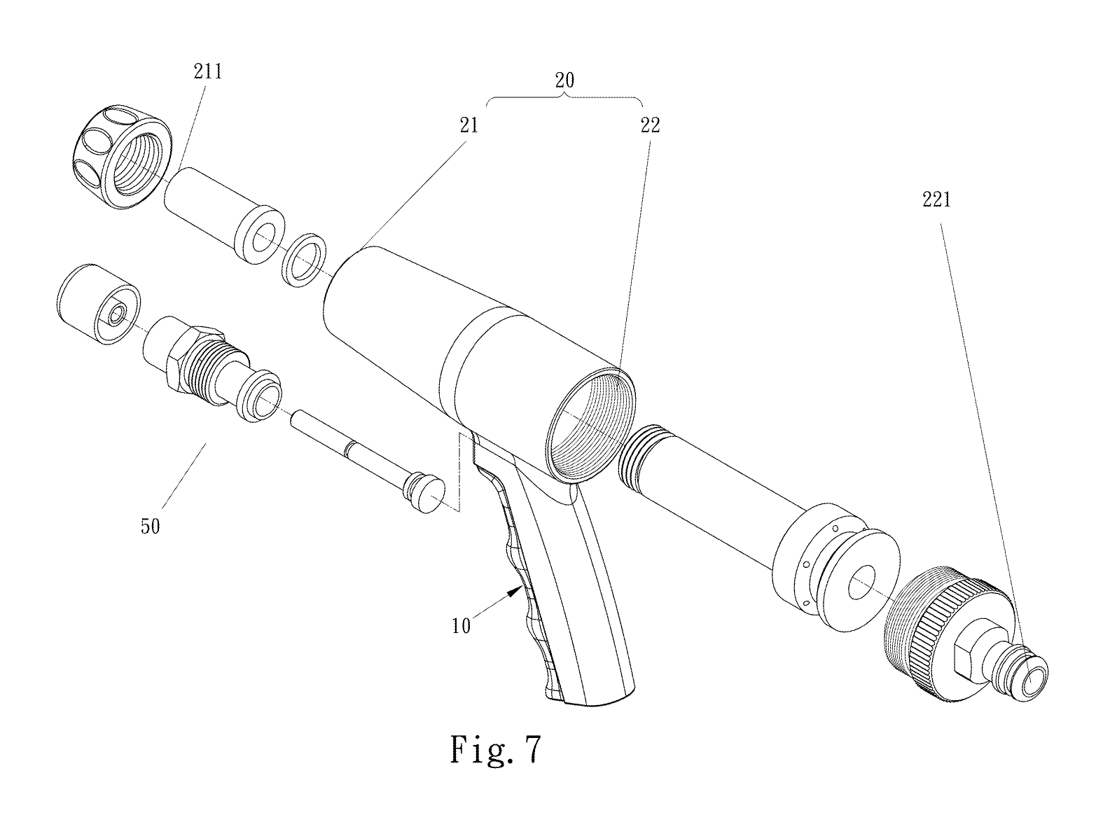

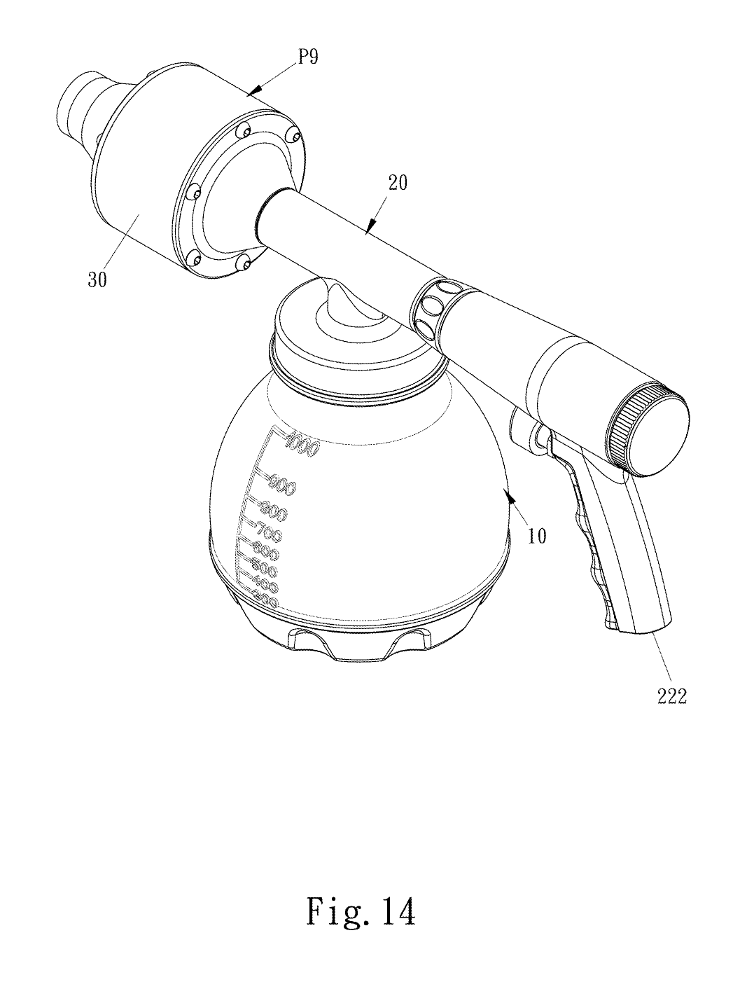

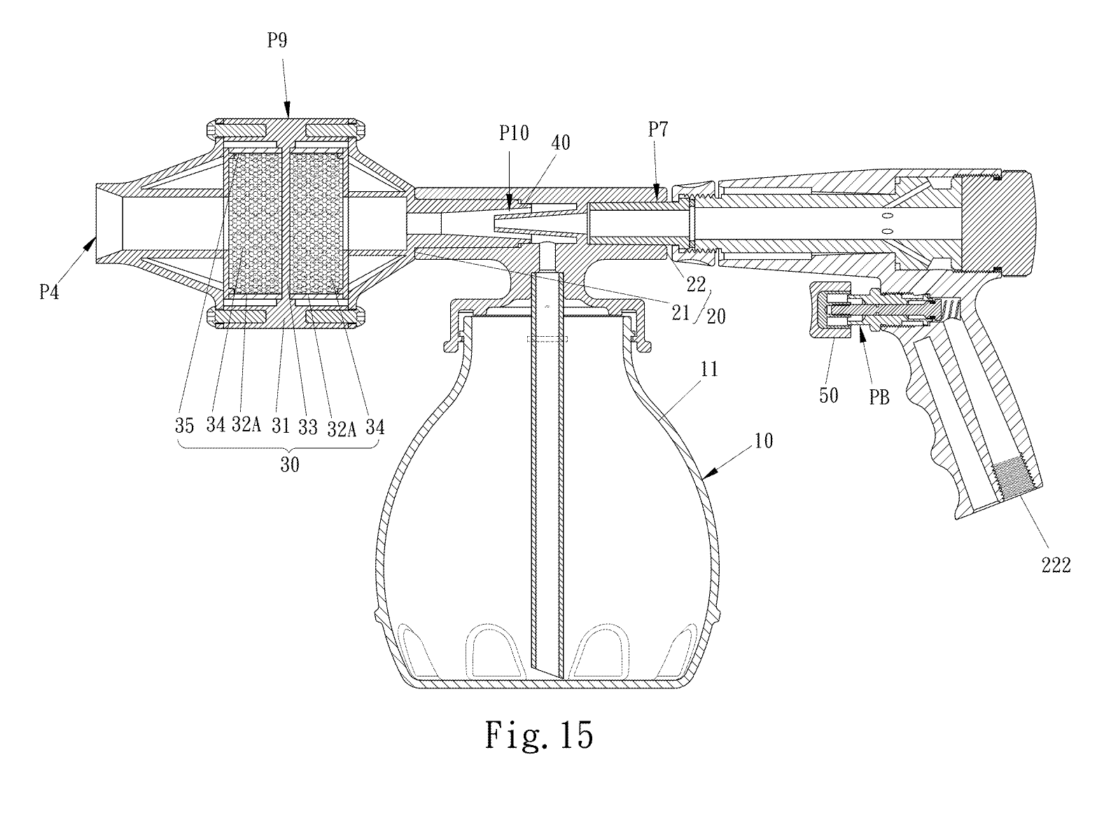

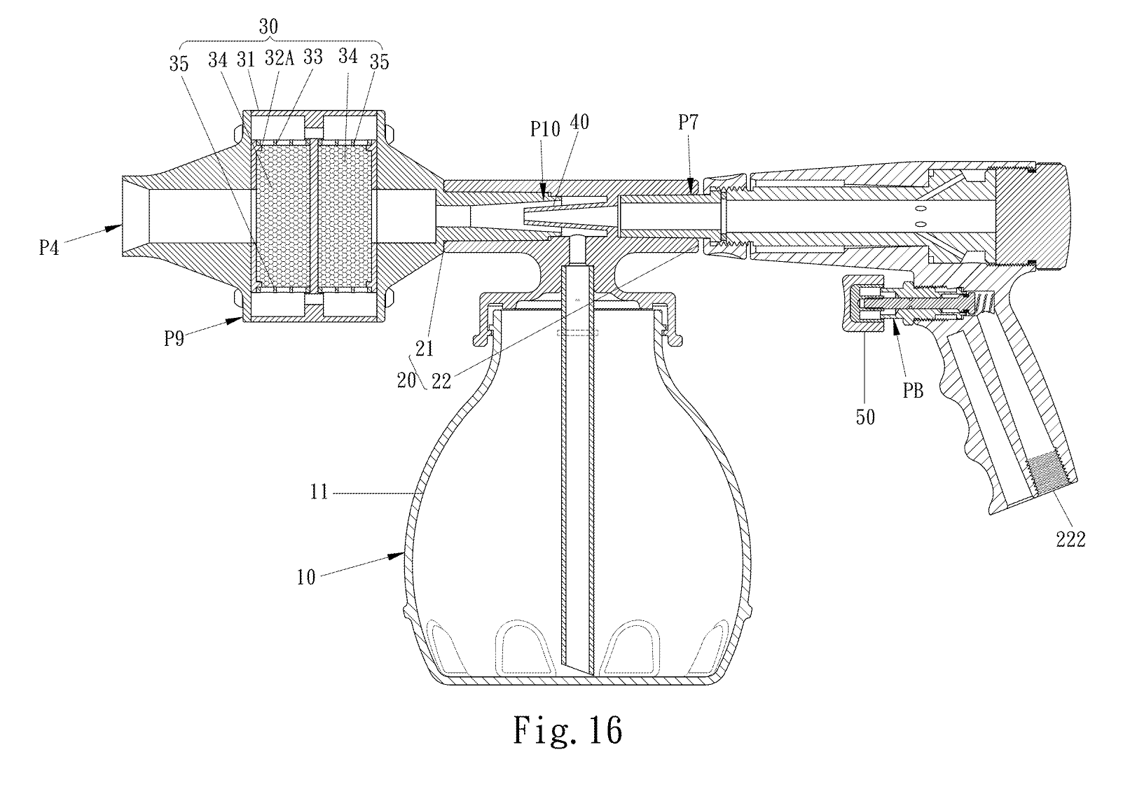

As shown in FIG. 1 to FIG. 17, the present invention discloses a multi-purpose fluid supply device. The multi-purpose fluid supply device comprises a main body portion 10, a working portion 20, a bubble generation portion 30, and a fluid guide portion 40.

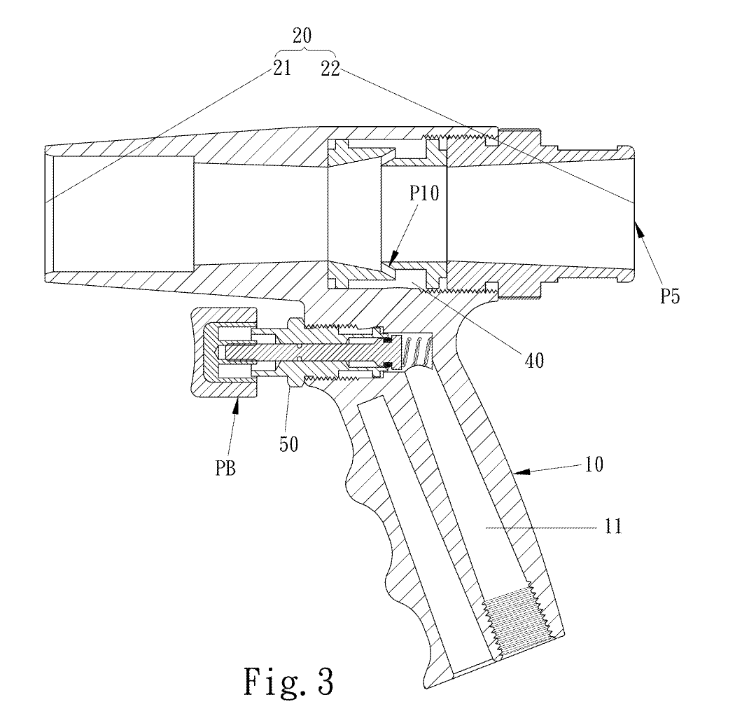

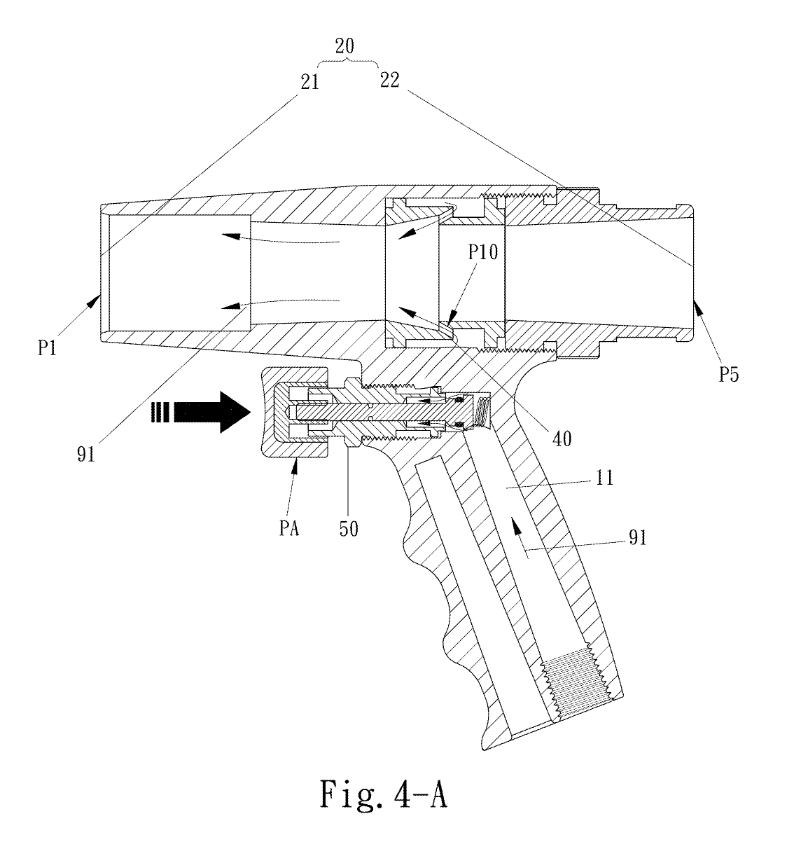

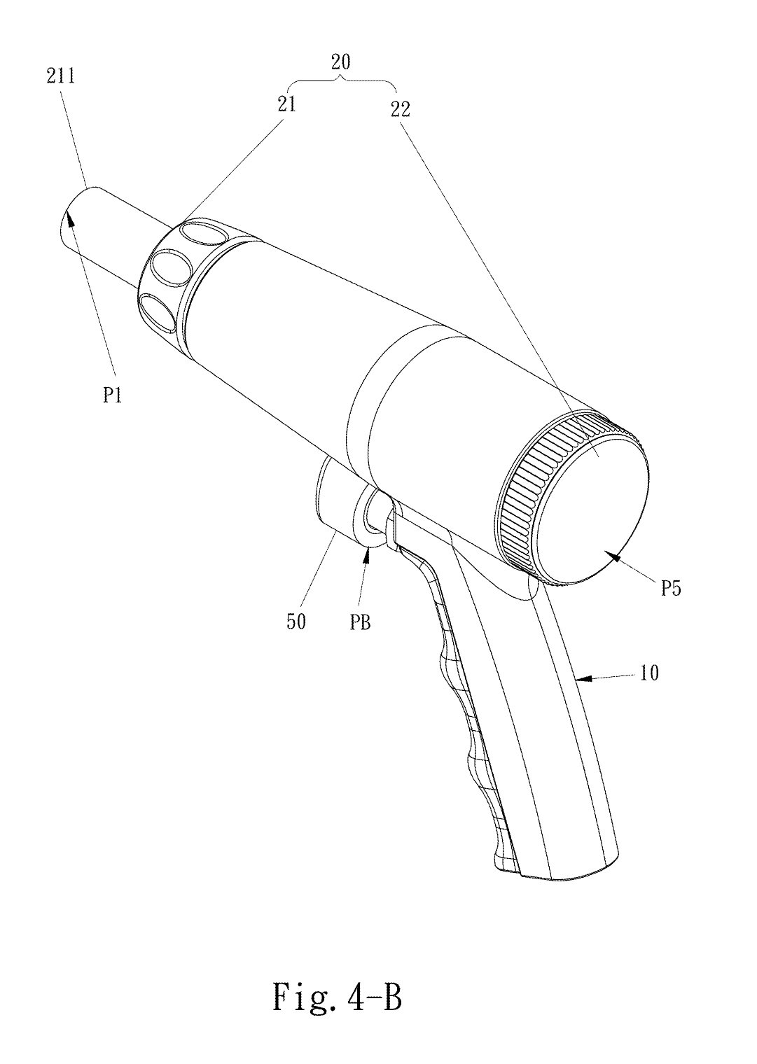

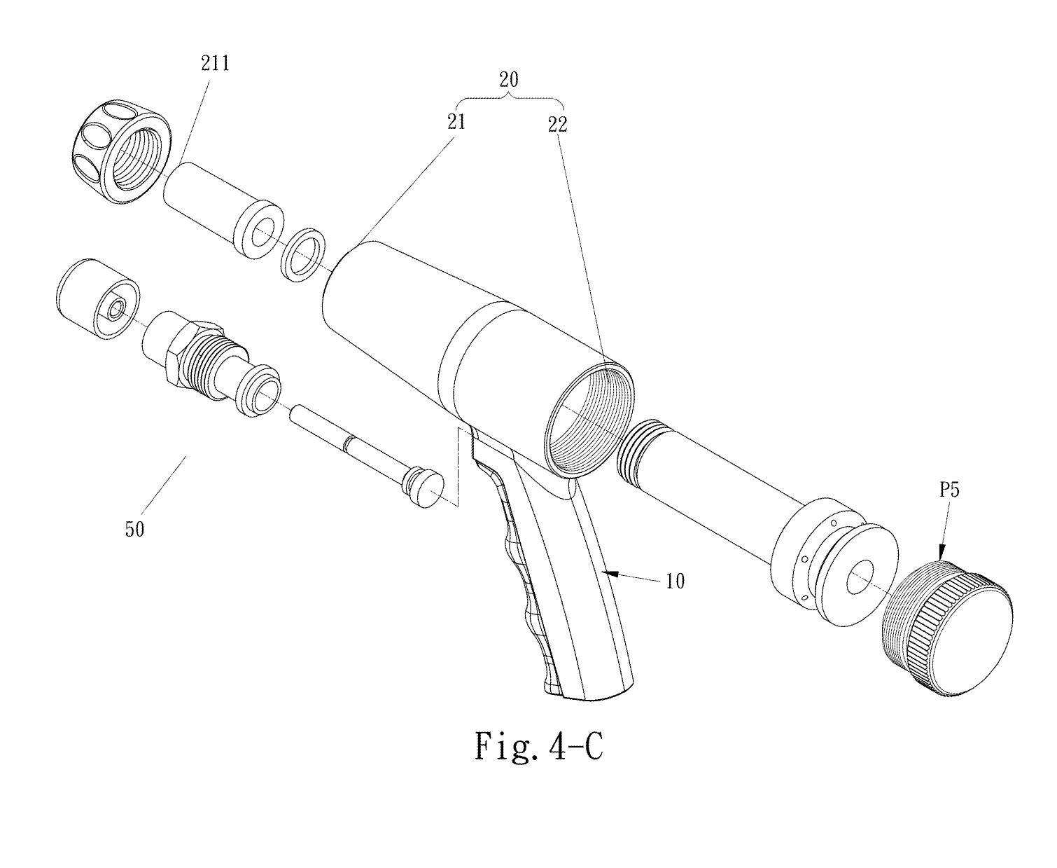

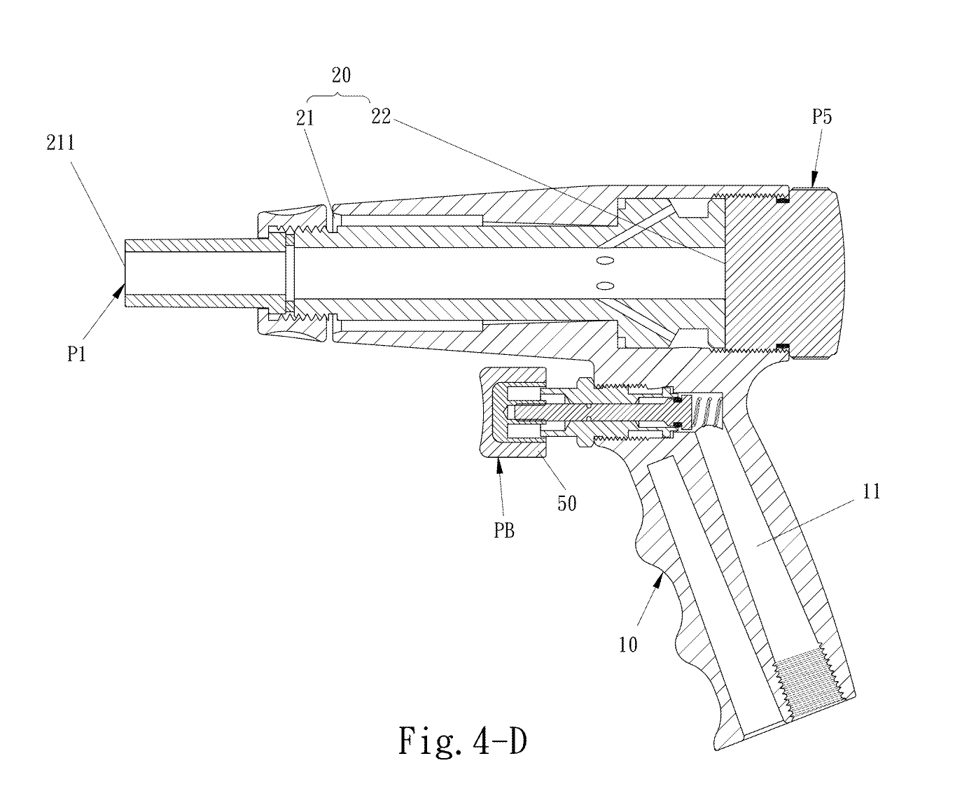

The main body portion 10 is provided with a fluid supply device 11. The fluid supply device 11 is changeable between an open position PA (referring to FIG. 4-A) and a closed position PB (referring to FIG. 3). When the fluid supply device 11 is located at the open position PA, it is adapted to supply one of a gas 91 and a liquid 92.

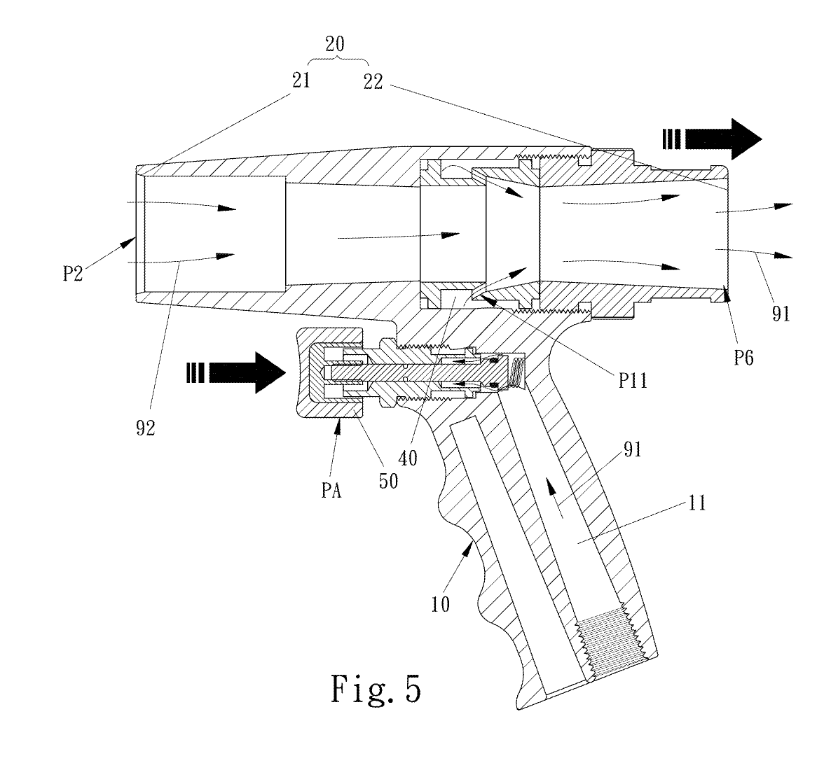

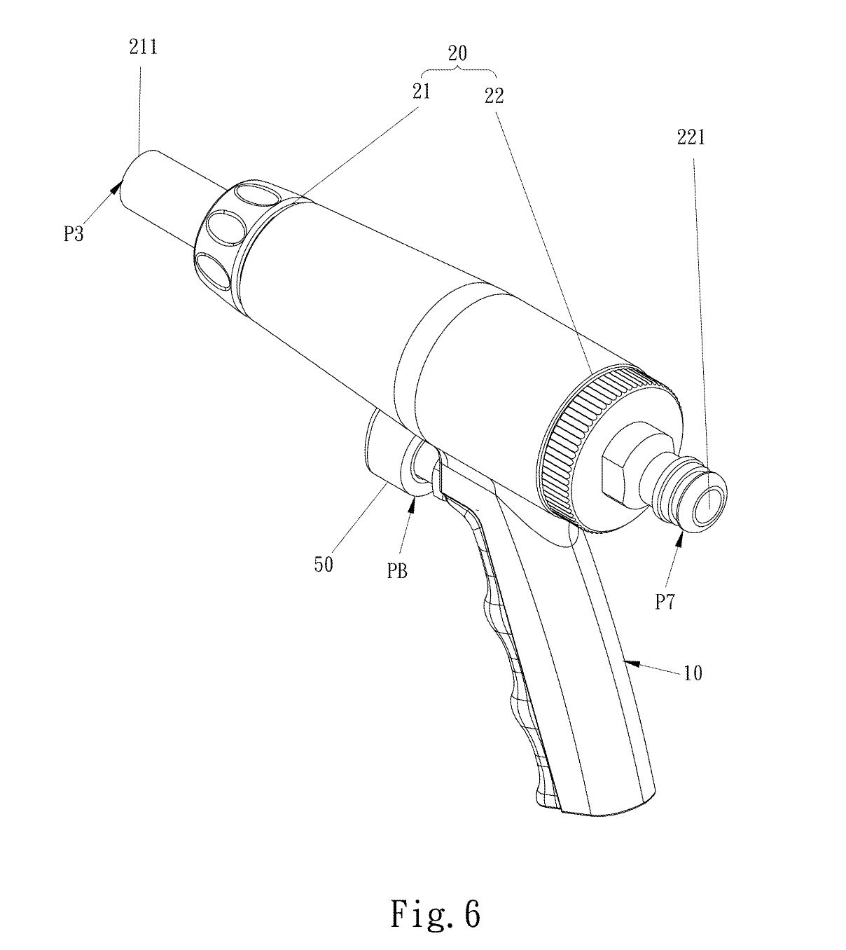

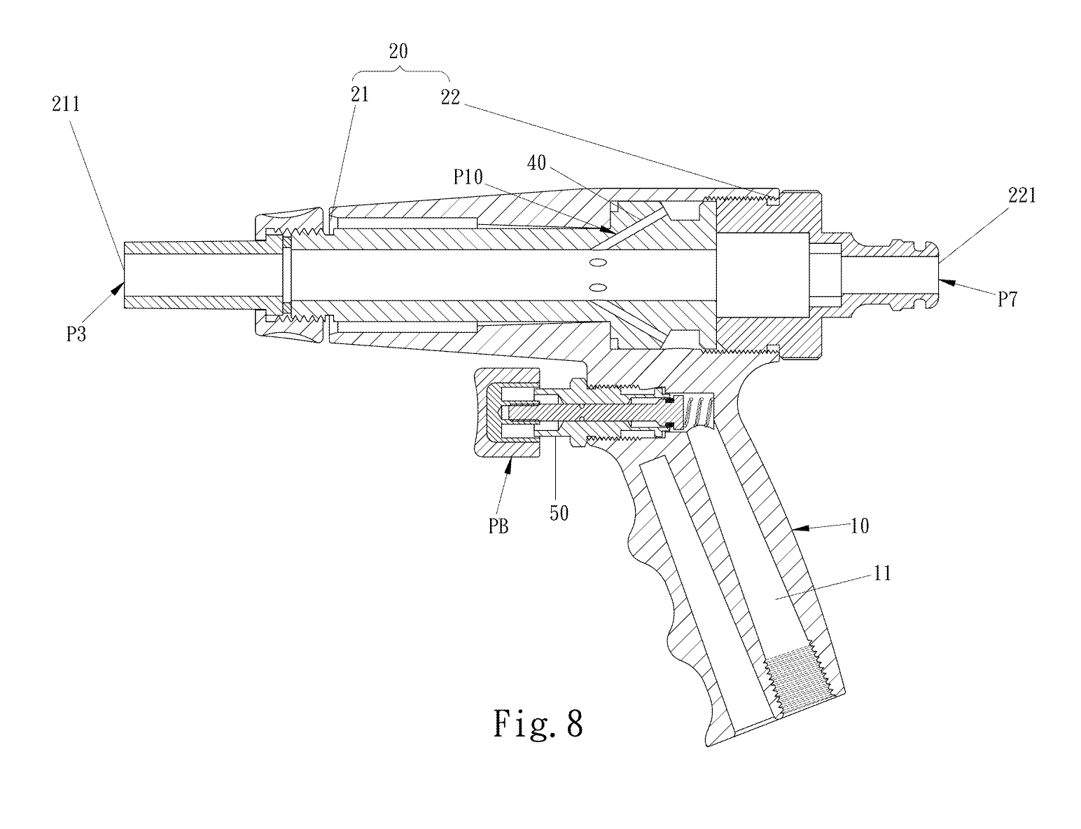

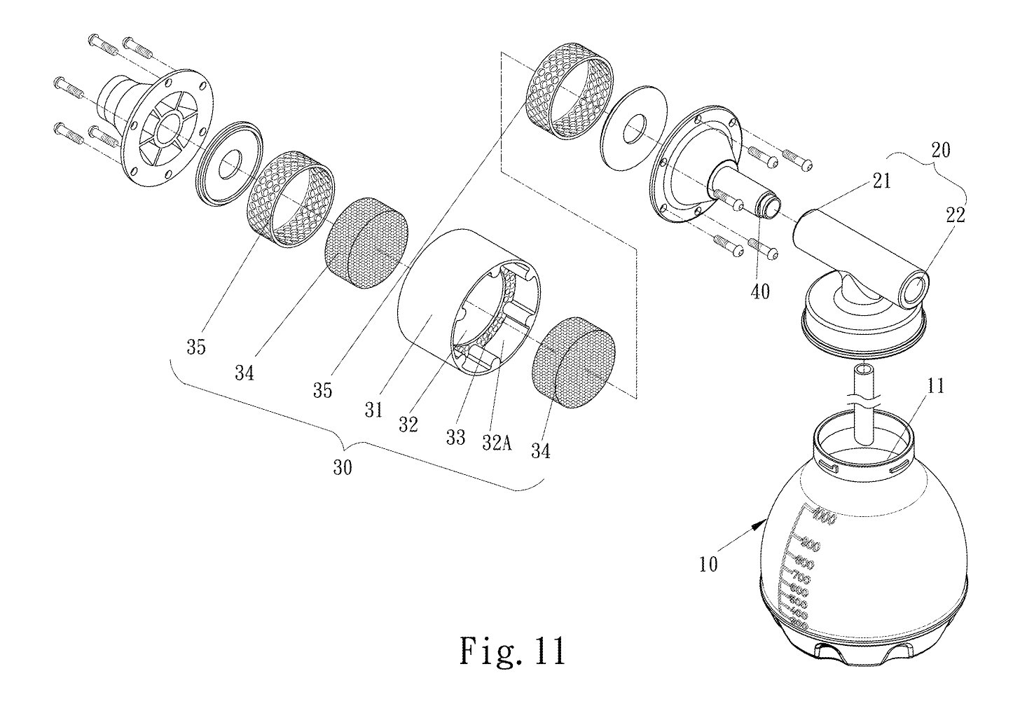

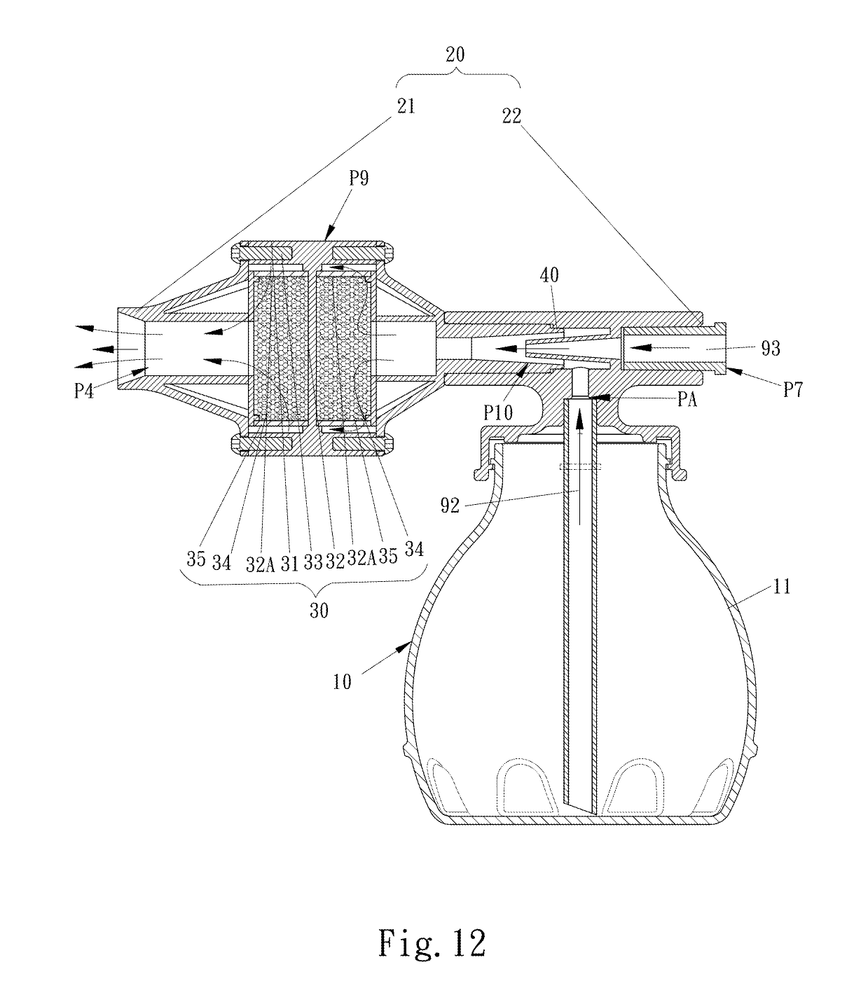

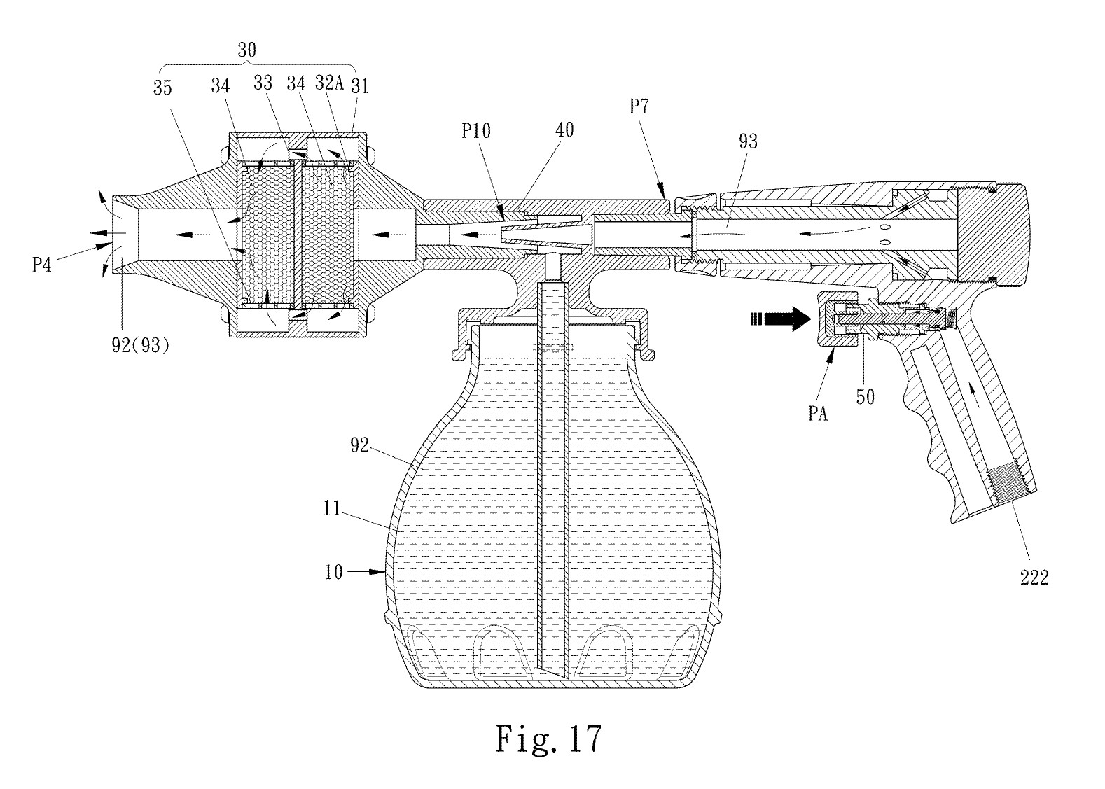

The working portion 20 is connected to the main body portion 10, and has a first working end 21 and a second working end 22. The fluid supply device 11, the first working end 21, and the second working end 22 communicate with each other. The first working end 21 is changeable among an air spray position P1 (referring to FIG. 4-A, FIG. 4-B, FIG. 4-C and FIG. 4-D), an air suction position P2 (referring to FIG. 5), a liquid spray position P3 (referring to FIG. 6 to FIG. 10), and a bubble spray position P4 (referring to FIG. 11 to FIG. 17). The second working end 22 is changeable among a working position P5 (as shown in FIG. 1, FIG. 4-A, FIG. 4-B, FIG. 4-C, and FIG. 4-D, it can be open or closed, not influencing the working condition), a dust collection position P6 (referring to FIG. 5), and a supply position P7 (referring to FIG. 8 to FIG. 10, FIG. 12, and FIG. 17).

The bubble generation portion 30 has a disconnection position P8 and a connection position P9 to disconnect from or connect with the first working end 21, respectively.

The fluid guide portion 40 is changeable between a forward position P10 and a rearward position P11.

The present invention can be changed among the following four modes:

Air spray mode: The fluid supply device 11 is located at the open position PA. The first working end 21 is located at the air spray position P1. The second working end 22 is located at the working position P5. The bubble generation portion 30 is located at the disconnection position P8, namely, the bubble generation portion 30 is disconnected. The fluid guide portion 40 is located at the forward position P10. The fluid supply device 11 supplies the gas 91 as shown in FIG. 4-A, and the fluid guide portion 40 guides the gas 91 to be sprayed through the first working end 21.

Dust collection mode: The fluid supply device 11 is located at the open position PA. The first working end 21 is located at the air suction position P2. The second working end 22 is located at the dust collection position P6. The bubble generation portion 30 is located at the disconnection position P8, namely, the bubble generation portion 30 is disconnected. The fluid guide portion 40 is located at the rearward position P11. The fluid supply device 11 supplies the gas 91, and the fluid guide portion 40 guides the gas 91 to collect dust, as shown in FIG. 5, from the first working end 21 toward the second working end 22.

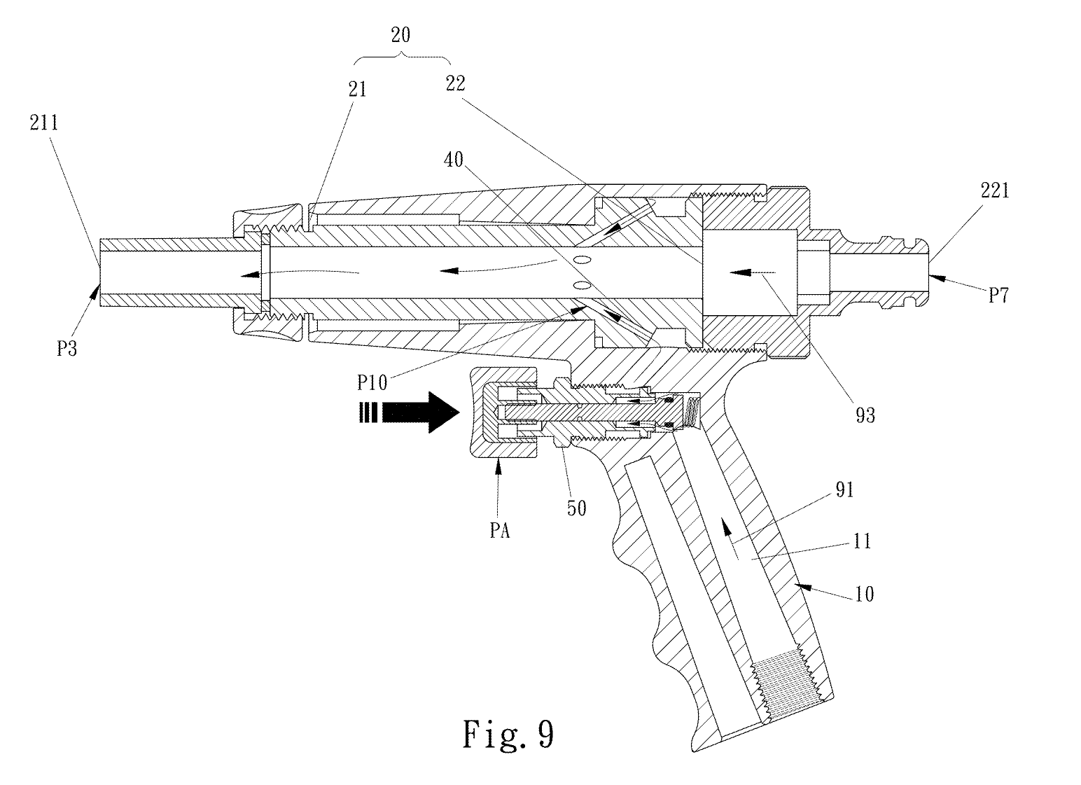

Water spray mode: The fluid supply device 11 is located at the open position PA. The first working end 21 is located at the liquid spray position P3. The second working end 22 is located at the supply position P7 (referring to FIG. 9). The bubble generation portion 30 is located at the disconnection position P8, namely, the bubble generation portion 30 is disconnected. The fluid guide portion 40 is located at the forward position P10. The second working end 22 supplies a working fluid 93 which is a liquid. The fluid supply device 11 supplies the gas 91, and the fluid guide portion 40 guides the gas 91 toward the first working end 11 to bring the working fluid 93 to spray water.

Bubble spray mode: The fluid supply device 11 is located at the open position PA. The first working end 21 is located at the bubble spray position P4. The second working end 22 is located at the supply position P7 (referring to FIG. 12). The bubble generation portion 30 is located at the connection position P9. The fluid guide portion 40 is located at the forward position P10. The second working end 22 supplies the working fluid 93 which is a gas. The fluid supply device 11 supplies the liquid 92. The working fluid 93 is guided by the fluid guide portion 40 to bring the liquid 92 toward the first working end 11 to pass the bubble generation portion 30. During passing, the liquid 92 is extruded repeatedly to spray bubble toward the first working end 21.

To practice the present invention, the first working end 21 is further provided with a spray nozzle 211 (referring to FIG. 4-B, FIG. 4-C, and FIG. 4-D) configured to reduce the first working end 21 to enhance air spray pressure.

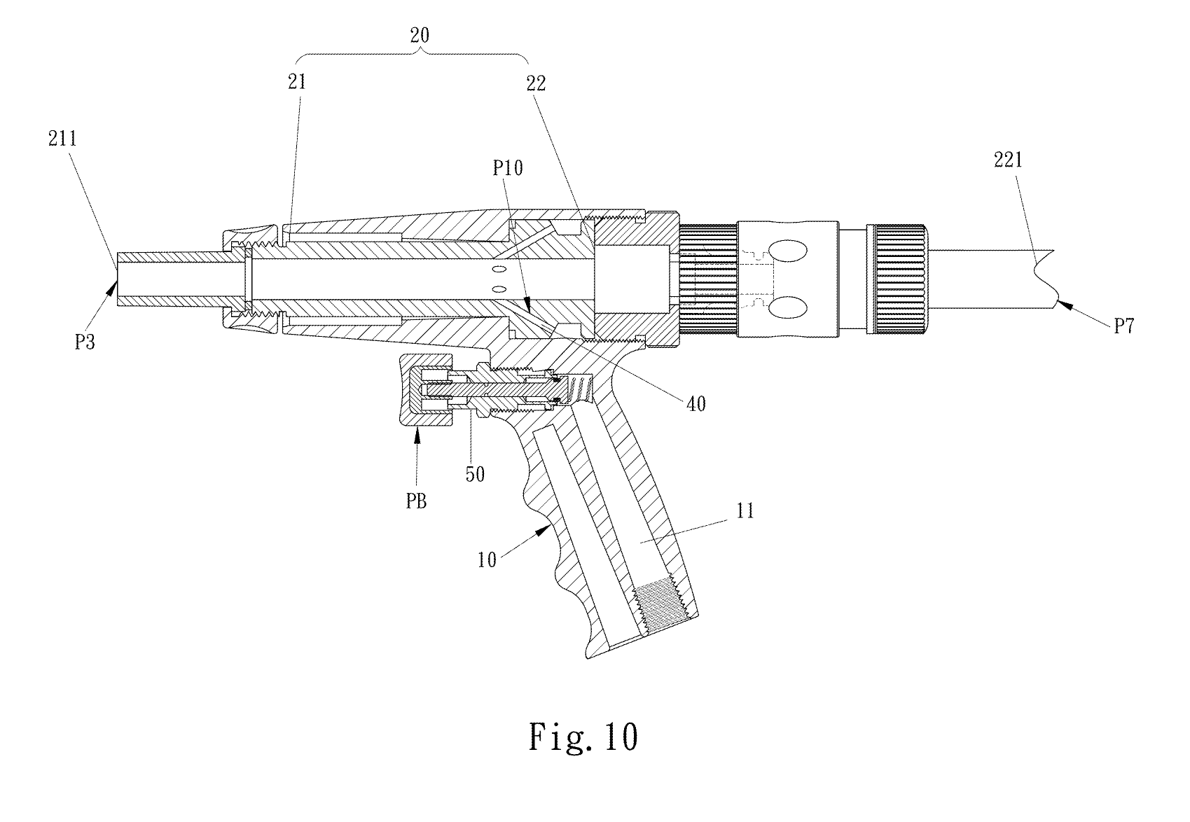

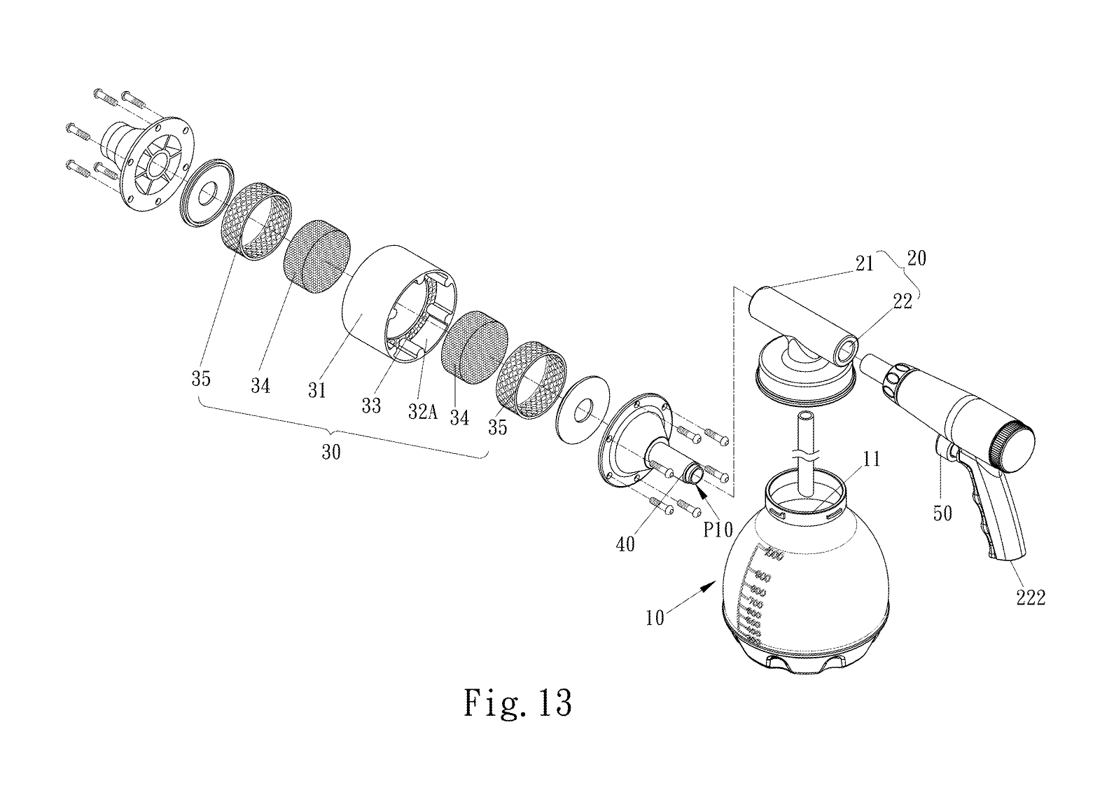

The second working end 22 further comprises a liquid inlet portion 221 (referring to FIG. 10, under the water spray mode) and an air inlet portion 222 (referring to FIG. 13 to FIG. 17, under the bubble spray mode). The liquid inlet portion 221 is adapted to supply the working fluid 93 which is a liquid to the second working end 22. The air inlet portion 222 is adapted to supply the working fluid 93 which is a gas to the second working end 22.

Referring to FIG. 11 to FIG. 17, the bubble generation portion 30 is connected to the working portion 20, and comprises a frame 31, a partition 32, a separation net 33, at least two foam members 34, and at least two limit nets 35.

The frame 31 is disposed on the first working end 21.

The partition 32 is configured to partition the frame 31 into two bubble generation spaces 32A. One of the two bubble generation spaces 32A faces and communicates with the first working end 21.

The separation net 33 is disposed between the frame 31 and the partition 32 and configured to communicate with the two bubble generation spaces 32A.

The at least two foam members 34 are disposed in the two bubble generation spaces 32A, respectively.

The at least two limit nets 35 are disposed between the partition 32 and the corresponding foam members 34, respectively.

The fluid guide portion 40 is disposed between the first working end 21 and the bubble generation portion 30, and configured to guide the liquid 92 from the fluid supply device 11 to flow toward the first working end 21.

Thus, the liquid 92 (it can be liquid soap) from the fluid supply device 11 is guided by the fluid guide portion 40 and brought by the working fluid 93 to flow toward the first working end 21. During the liquid 92 passes the two bubble generation spaces 32A in sequence, it is repeatedly foamed by the two limit nets 35, the two foam members 34 and the separation net 33 to spray bubbles.

The foam member 34 can be a sponge.

The present invention further comprises a valve 50. The valve 50 is disposed on one of the fluid supply device 11 and the air inlet portion 222.

When the valve 50 is disposed on the fluid supply device 11, it is adapted to control the fluid supply device 11 to be changed between the open position PA and the closed position PB.

When the valve 50 is disposed on the air inlet portion 222, it is adapted to supply and stop the working fluid 93 which is a gas.

The present invention provides the following four use modes.

[A] Air spray gun: When the first working end 21 is changed to the air spray position P1, the second working end 22 is changed to the working position P5, the bubble generation portion 30 is disconnected (as shown in FIG. 1, the bubble generation portion 30 is changed to the disconnection position P8), and the fluid guide portion 40 is adjusted to the forward position P10, the valve 50 controls the fluid supply device 11 at the open position PA to supply the gas 91 (as shown in FIG. 4-A), and the fluid guide portion 40 guides the gas 91 to be sprayed through the first working end 21 to achieve an air spray gun function.

[B] Dust collection gun: When the first working end 21 is changed to the air suction position P2, the second working end 22 is changed to the dust collection position P6, the bubble generation portion 30 is still disconnected, and the fluid guide portion 40 is adjusted to the rearward position P11, the valve 50 controls the fluid supply device 11 at the open position PA to supply the gas 91, and the fluid guide portion 40 guides the gas 91 to collect dust (as shown in FIG. 5) from the first working end 21 toward the second working end 22 to achieve a dust collection gun function.

[C] Water spray gun: When the first working end 21 is changed to the liquid spray position P3, the second working end 22 is changed to the supply position P7 (referring to FIG. 9), the bubble generation portion 30 is also disconnected, the fluid guide portion 40 is adjusted to the forward position P10, and the second working end 22 supplies the working fluid 93 which is liquid, the valve 50 controls the fluid supply device 11 at the open position PA to supply the gas 91, and the gas 91 is guided by the fluid guide portion 40 toward the first working end 21 to bring the working fluid 93 to spray water to achieve a water spray gun function.

[D] Bubble spray gun: When the first working end 21 is changed to the bubble spray position P4, the second working end 22 is changed to the supply position P7 (referring to FIG. 12), the bubble generation portion 30 is connected to the first working end 21 (located at the connection position P9), and the fluid guide portion 40 is also located at the forward position P10, the valve 50 controls the second working end 22 to supply the working fluid 93 which is a gas (referring to FIG. 17), and the working fluid 93 is guided by the fluid guide portion 40 to bring the liquid 92 from the fluid supply device 11 to flow toward the first working end 11. When passing the bubble generation portion 30, it is extruded repeatedly to spray bubble toward the first working end 21 to achieve a water spray gun function.

The advantages of the present invention are as follows.

[1] The four-in-one gun is quite novel. The present invention can be used as an air spray gun, a dust collection gun, a water spray gun or a bubble spray gun by means of controlling the disconnection and connection of the bubble generation portion and cooperating with the adjustment of the fluid guide portion to achieve a four-in-one gun so it is quite novel.

[2] It can be used widely. The present invention is a mobile device. It can be moved according to the demand of use to overcome the shortcomings of the prior art so it can be used widely.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A multi-purpose fluid supply device, comprising:
a main body portion provided with a fluid supply device, the fluid supply device being changeable between an open position and a closed position, wherein when the fluid supply device is located at the open position, the fluid supply device is adapted to supply one of a gas and a liquid;
a working portion connected to the main body portion, the working portion having a first working end and a second working end; the fluid supply device, the first working end, and the second working end communicating with each other; the first working end being changeable among an air spray position, an air suction position, a liquid spray position, and a bubble spray position; the second working end being changeable among a working position, a dust collection position, and a supply position;
a bubble generation portion having a disconnection position and a connection position to disconnect from or connect with the first working end, respectively; and
a fluid guide portion changeable between a forward position and a rearward position;
wherein, the multi-purpose fluid supply device can be changed among the following four modes:
air spray mode: the fluid supply device being located at the open position, the first working end being located at the air spray position, the second working end being located at the working position, the bubble generation portion being at the disconnection position, the fluid guide portion being located at the forward position, the fluid supply device supplying the gas, the fluid guide portion guiding the gas to be sprayed through the first working end;
dust collection mode: the fluid supply device being located at the open position, the first working end being located at the air suction position; the second working end being located at the dust collection position, the bubble generation portion being located at the disconnection position, the fluid guide portion being located at the rearward position, the fluid supply device supplying the gas, the fluid guide portion guiding the gas to collect dust from the first working end toward the second working end;
water spray mode: the fluid supply device being located at the open position, the first working end being located at the liquid spray position, the second working end being located at the supply position, the bubble generation portion being located at the disconnection position; the fluid guide portion being located at the forward position, the second working end supplying a working fluid which is a liquid; the fluid supply device supplying the gas, the fluid guide portion guiding the gas toward the first working end to bring the working fluid to spray water;
bubble spray mode: the fluid supply device being located at the open position, the first working end being located at the bubble spray position, the second working end being located at the supply position, the bubble generation portion being located at the connection position; the fluid guide portion being located at the forward position, the second working end supplying the working fluid which is a gas; the fluid supply device supplying the liquid, the working fluid being guided by the fluid guide portion to bring the liquid toward the first working end to pass the bubble generation portion, during passing, the liquid being extruded repeatedly to spray bubble toward the first working end.

2. The multi-purpose fluid supply device as claimed in claim 1, wherein the first working end of the working portion is provided with a spray nozzle configured to reduce the first working end to enhance air spray pressure.

3. The multi-purpose fluid supply device as claimed in claim 1, wherein when the multi-purpose fluid supply device is changed to the water supply mode, the second working end of the working portion further comprises a liquid inlet portion adapted to supply the working fluid which is a liquid to the second working end.

4. The multi-purpose fluid supply device as claimed in claim 1, wherein when the multi-purpose fluid supply device is changed to the bubble supply mode, the second working end of the working portion further comprises an air inlet portion adapted to supply the working fluid which is a gas to the second working end.

5. The multi-purpose fluid supply device as claimed in claim 1, wherein the bubble generation portion comprises:
a frame, disposed on the first working end;
a partition, configured to partition the frame into two bubble generation spaces, one of the two bubble generation spaces facing and communicating with the first working end;
a separation net, disposed between the frame and the partition and configured to communicate with the two bubble generation spaces;
at least two foam members disposed in the two bubble generation spaces, respectively; and
at least two limit nets disposed between the partition and the corresponding foam members, respectively.

6. The multi-purpose fluid supply device as claimed in claim 5, wherein the foam members are sponges.

7. The multi-purpose fluid supply device as claimed in claim 1, further comprising a valve, the valve being disposed on one of the fluid supply device and the air inlet portion of the second working end of the working portion; wherein when the valve is disposed on the fluid supply device, the valve is adapted to control the fluid supply device to be changed between the open position and the closed position; wherein when the valve is disposed on the air inlet portion, the valve is adapted to supply and stop the working fluid which is a gas.

8. The multi-purpose fluid supply device as claimed in claim 4, further comprising a valve, the valve being disposed on one of the fluid supply device and the air inlet portion of the second working end of the working portion; wherein when the valve is disposed on the fluid supply device, the valve is adapted to control the fluid supply device to be changed between the open position and the closed position; wherein when the valve is disposed on the air inlet portion, the valve is adapted to supply and stop the working fluid which is a gas.
